(19) United States
(12) Patent Application Publication
(10) Pub. No.: US 2015/0160817 A1
(43) Pub. Date: Jun. 11, 2015

(54) SEARCH RESULTS INCLUDING SUPPLEMENTAL CONTENT TRIGGERED BY USER ACTIONS WHEN BROWSING THE SEARCH RESULTS

(71) Applicants: Yong Soo HWANG, Seoul (KR); Junyoung LEE, Mountain View, CA (US); Seongjin CHO, Seoul (KR)

(72) Inventors: Yong Soo HWANG, Seoul (KR); Junyoung LEE, Mountain View, CA (US); Seongjin CHO, Seoul (KR)

(73) Assignee: GOOGLE INC., Mountain View, CA (US)

(21) Appl. No.: 13/443,250

(22) Filed: Apr. 10, 2012

(51) Int. Cl. G06F 3/0485; G06F 17/30

(52) U.S. Cl. CPC G06F 3/0485; G06F 17/30864

(57) ABSTRACT

Supplemental content, such as suggested search queries, that are related to a search query and distinct from search results for the search query, may be provided to a user. A device may receive a search query from a user; and obtain a search result document responsive to the search query, where the search result document may include one or more search results that are initially presented to the user and one or more suggested search queries, relating to the search query, that are initially not presented to the user. The device may detect performance of a sequence of actions by the user, the sequence of actions including a scroll down operation followed by a scroll up operation. The device may present the one or more suggested search queries to the user in response to the detection of the sequence of actions.

### BACKGROUND

Many techniques are available to users today to find information on the world wide web (“web”). For example, users often use web browsers and/or search engines to find information of interest. In response to a search query, a search engine may return search results that include references to documents relevant to the search query.

Search results can be augmented with supplemental content, such as suggestions for additional search queries that may be related to the search query entered by the user. The supplemental content may also be provided, to the user, along with the search results.

### SUMMARY

One possible implementation may be directed to a method performed by one or more devices. The method may include receiving a search query from a user; obtaining a search result document responsive to the search query, the search result document including one or more search results that are initially presented to the user and one or more suggested search queries, relating to the search query, that are initially not presented to the user. The method may further include detecting performance of a sequence of actions by the user, the sequence of actions including a scroll down operation followed by a scroll up operation; and presenting, by the device, the one or more suggested search queries to the user in response to the detection of the sequence of actions.

In another possible implementation, a computer-readable medium may include one or more instructions, which when executed by one or more processors, cause the one or more processors to receive a search query from a user; one or more instructions, which when executed by the one or more processors, cause the one or more processors to obtain a search result document responsive to the search query, the search result document including one or more search results that are initially presented to the user and one or more suggested search queries, relating to the search query, that are initially not presented to the user; one or more instructions, which when executed by the one or more processors, cause the one or more processors to detect performance of a sequence of actions by the user, the sequence of actions including a scroll down operation followed by a scroll up operation; and one or more instructions, which when executed by the one or more processors, cause the one or more processors to present the one or more suggested search queries to the user in response to the detection of the sequence of actions.

In yet another possible implementation, a computing device may include a memory to store instructions and one or more processors, to execute the instructions. The instructions may be executed to: receive a search query from a user; obtain a search result document responsive to the search query, the search result document including one or more search results that are initially presented to the user and one or more suggested search queries, relating to the search query, that are initially not presented to the user; detect performance of a sequence of actions by the user, the sequence of actions including a scroll down operation followed by a scroll up operation; and present the one or more suggested search queries to the user in response to the detection of the sequence of actions.

### BRIEF DESCRIPTION OF THE DRAWINGS

The accompanying drawings, which are incorporated in and constitute a part of this specification, illustrate one or more embodiments described herein and, together with the description, explain these embodiments. In the drawings:

FIGS. 1A and 1B are diagrams illustrating an example of a search session performed on a mobile device;

FIG. 2 is a diagram of an example environment in which techniques described herein may be implemented;

FIG. 3 shows an example of a generic computing device and a generic mobile computing device;

FIG. 4 is a diagram of example functional components relating to the inclusion of supplemental content, in a search result document, in response to user actions;

FIG. 5 is a flow chart of an example process for including supplemental content in a search result document;

FIG. 6 is a flow chart of an example process, according to another possible implementation, for including supplemental content in a search result document;

FIG. 7 is a flow chart of an example process for presenting supplemental content to a user; and

FIGS. 8A-8C are diagrams illustrating examples of user interfaces that may be provided to a user.

### DETAILED DESCRIPTION

The following detailed description refers to the accompanying drawings. The same reference numbers in different drawings may identify the same or similar elements.

### Overview

User actions, when interacting with search results, may be monitored, and certain actions may be used to trigger modification of the provided search results. For example, if a user performs a “scroll down” operation followed by a “scroll up” operation, when navigating a search result document, the search result document may be modified to include suggested search queries, at a top of a search result document. In this situation, the scroll down operation followed by the scroll up operation may be an indication that the user has viewed the top search results, was not satisfied with the top search results, and is navigating back to the top of the search result document to enter a new search query. Providing additional potential search queries at the top of the search result document may save the user from having to type a new search query.

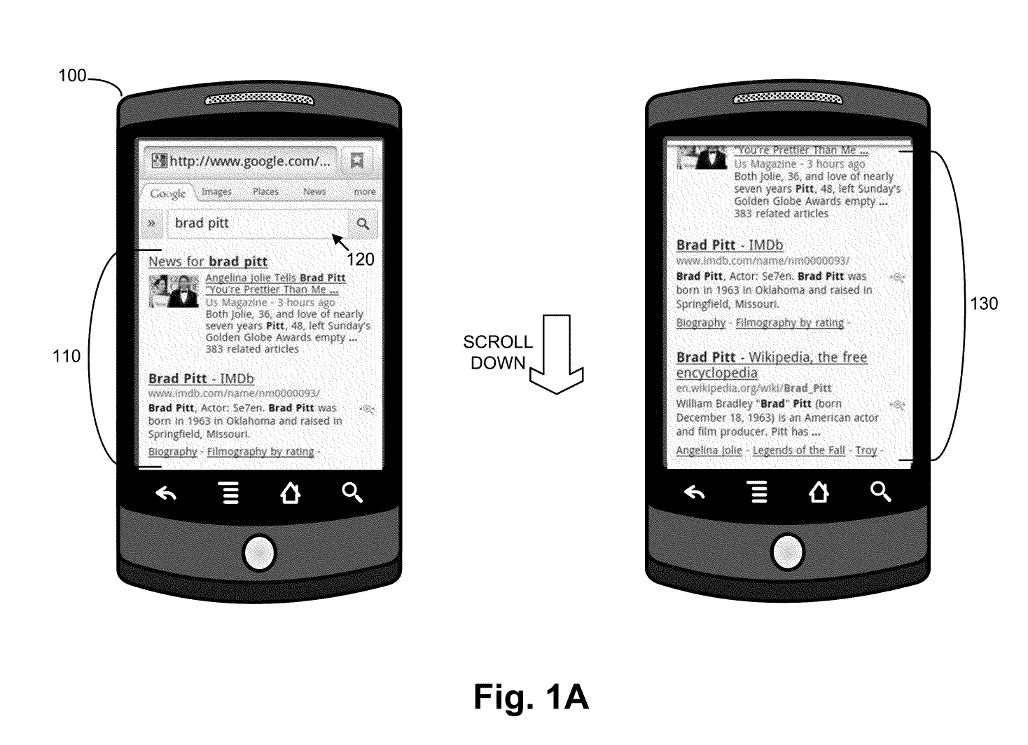

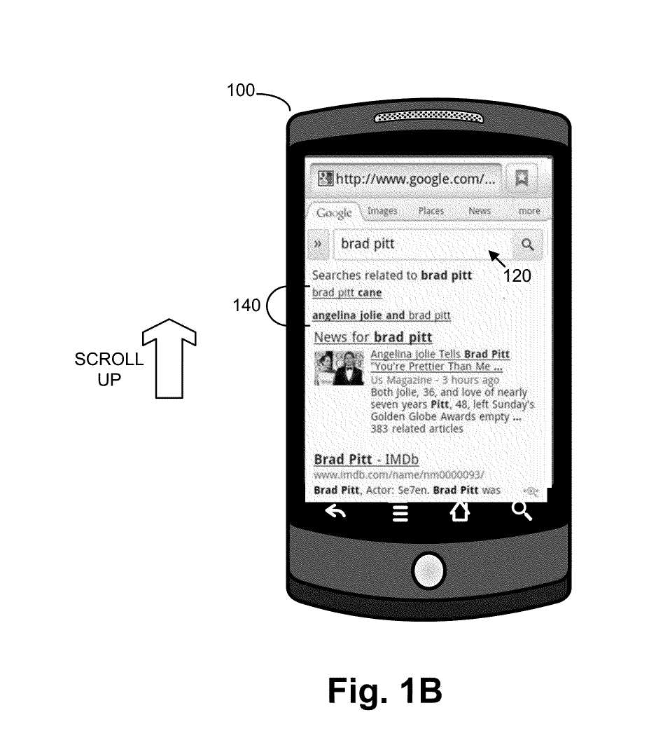

FIGS. 1A and 1B are diagrams illustrating an example of a search session performed on a mobile device. Assume that a user desires to find information relating to the search query “brad pitt.” As shown in FIG. 1A, a number of search results 110 may be initially presented on a screen of a mobile device 100. Search results 110 may be provided below a search box 120, in which a user may enter a search query. The screen of mobile device 100 may be a touch sensitive screen, allowing the user to scroll down, to view additional results of search results 110, using a touch operation. Search results 130 may represent the viewable search results after a scroll down operation. Referring to FIG. 1B, assume that the user does not find a desirable result in search results 110 and 130. The user may perform a scroll up operation to access search box 120. Consistent with aspects described herein, the combination of the scroll down operation followed by a scroll up operation may trigger the modification of search results 110/130. Accordingly, as shown in FIG. 1B, mobile device 100 may provide, below search box 120, supplemental content that was not initially provided to the user, such as search query suggestions 140 in which the user may be interested. The user may select one of search query suggestions 140 to initiate a new search using the selected search query suggestion rather than having to enter a new search query into search box 120. The user's search experience may be improved as the user may not need to type a new search. This can be particularly useful for devices, such as mobile devices, in which typing text can be a relatively cumbersome task.

The trigger condition shown in FIGS. 1A and 1B, a scroll down operation followed by scroll up operation, is an example of a sequence of operations that may be used to trigger the providing of supplemental content. In alternative implementations, other trigger conditions, such as a single scroll up operation or another operation or sequence of operations, may be used to trigger the providing of the supplemental content. Additionally, although search query suggestions 140 are illustrated in FIGS. 1A and 1B as an example of supplemental content, other types of supplemental content may alternatively be provided.

The concepts described herein may be applied to documents. A document may be broadly interpreted to include any machine-readable and machine-storable work product. A document may include, for example, an e-mail, a web site, a file, a combination of files, one or more files with embedded links to other files, a news group posting, a news article, a blog, a business listing, an electronic version of printed text, a web advertisement, etc. In the context of the Internet, a common document is a web page. Documents often include textual information and may include embedded information, such as meta information, images, hyperlinks, etc., and/or embedded instructions, such as Javascript, etc. A link, as the term is used herein, is to be broadly interpreted to include any reference to/from a document from/to another document or another part of the same document.

### System Overview

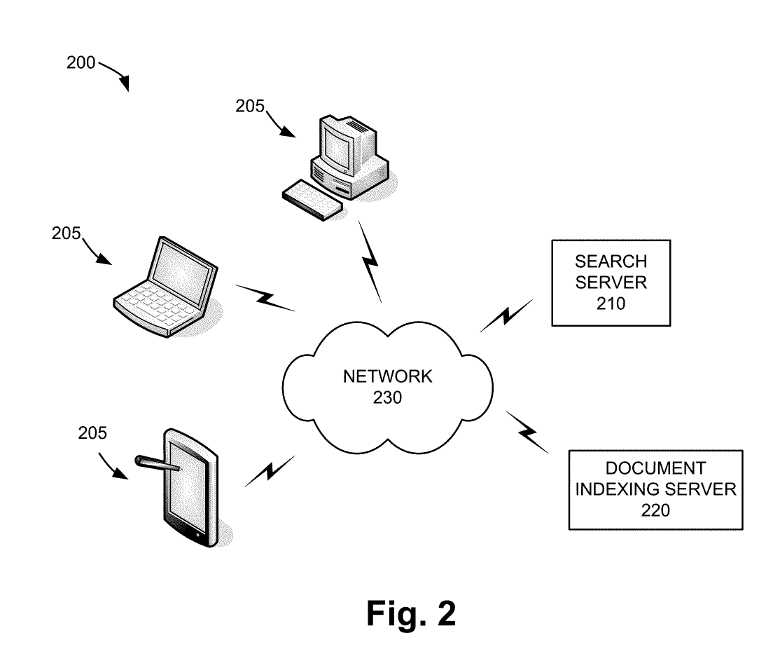

FIG. 2 is a diagram of an example environment 200 in which techniques described herein may be implemented. Environment 200 may include multiple clients 205 connected to one or more servers 210-220 via a network 230. In one implementation, and as illustrated, server 210 may be a search server, which may implement a search engine, and server 220 may be a document indexing server, e.g., a web crawler and/or other indexer. Clients 205 and servers 210-220 may connect to network 230 via wired, wireless, or a combination of wired and wireless connections.

Three clients 205 and two servers 210-220 are illustrated as connected to network 230 for simplicity. In practice, there may be additional or fewer clients and servers. Also, in some instances, a client may perform one or more functions of a server and a server may perform one or more functions of a client.

Clients 205 may include devices of users that access servers 210-220. A client 205 may include, for instance, a personal computer, a wireless telephone, a personal digital assistant (PDA), a laptop, a smartphone, a tablet computer, or another type of computation or communication device. Servers 210-220 may include devices that access, fetch, aggregate, process, search, provide, and/or maintain documents. Although shown as single servers 210 and 220 in FIG. 2, each server 210 and 220 may, in some implementations, be implemented as multiple computing devices, which potentially may be geographically distributed.

Search server 210 may include one or more computing devices designed to implement a search engine, such as an image search engine, general web page search engine, etc. Search server 210 may, for example, include one or more web servers to receive search queries from clients 205, search one or more memories to identify documents relevant to the search queries, and present links to the documents to clients 205.

Document indexing server 220 may include one or more computing devices designed to index documents available through network 230. Document indexing server 220 may access other servers, such as web servers that host content, to index the content. Document indexing server 220 may provide its index to search server 210, for use by search server 210 when handling search queries.

While servers 210-220 are shown as separate entities, it may be possible for one of servers 210-220 to perform one or more of the functions of the other one of servers 210-220. For example, it may be possible that servers 210 and 220 are implemented as a single server. It may also be possible for a single one of servers 210 and 220 to be implemented as two or more separate, and possibly distributed, devices.

Network 230 may include one or more networks of any type, such as a local area network (LAN), a wide area network (WAN), a metropolitan area network (MAN), a telephone network, such as the Public Switched Telephone Network (PSTN) or a Public Land Mobile Network (PLMN), an intranet, the Internet, a memory device, or a combination of networks.

Although FIG. 2 shows example components of environment 200, in other implementations, environment 200 may contain fewer components, different components, differently arranged components, and/or additional components than those depicted in FIG. 2. Alternatively, or additionally, one or more components of environment 200 may perform one or more other tasks described as being performed by one or more other components of environment 200.

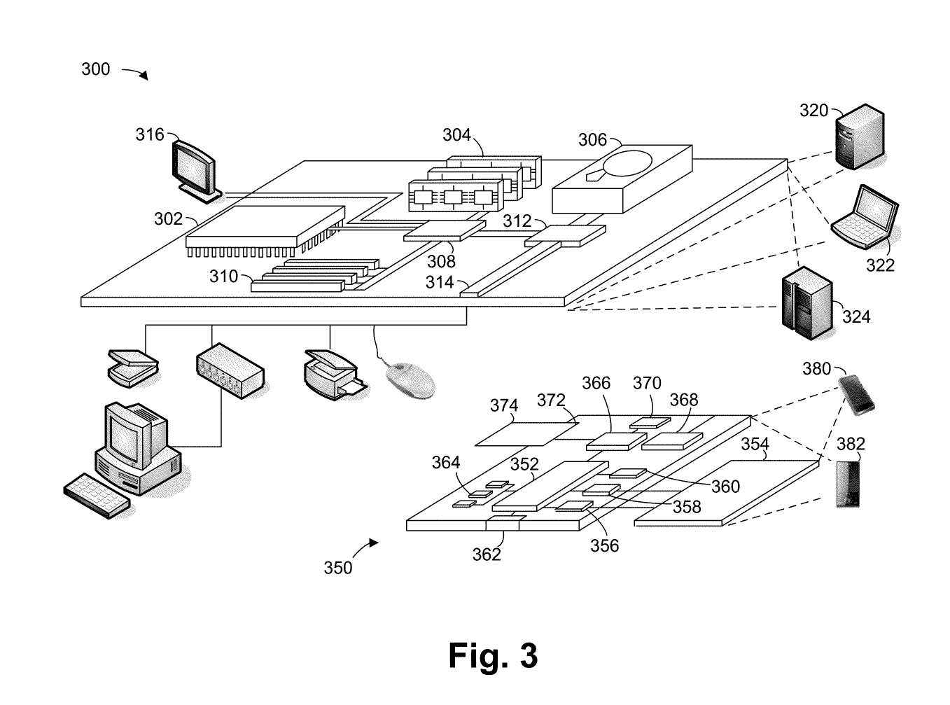

FIG. 3 shows an example of a generic computing device 300 and a generic mobile computing device 350, which may be used with the techniques described herein. Computing device 300 may correspond to, for example, client 205 and/or server 210/220. For example, each of clients 205 and servers 210/220 may include one or more computing devices 300. Mobile computing device 350 may correspond to, for example, portable implementations of clients 205.

Computing device 300 is intended to represent various forms of digital computers, such as laptops, desktops, workstations, personal digital assistants, servers, blade servers, mainframes, and other appropriate computers. Mobile computing device 350 is intended to represent various forms of mobile devices, such as personal digital assistants, cellular telephones, smart phones, and other similar computing devices. The components shown here, their connections and relationships, and their functions, are meant to be examples only, and are not meant to limit implementations described and/or claimed in this document.

Computing device 300 may include a processor 302, memory 304, a storage device 306, a high-speed interface 308 connecting to memory 304 and high-speed expansion ports 310, and a low speed interface 312 connecting to low speed bus 314 and storage device 306. Each of the components 302, 304, 306, 308, 310, and 312, may be interconnected using various busses, and may be mounted on a common motherboard or in other manners as appropriate. Processor 302 may process instructions for execution within computing device 300, including instructions stored in the memory 304 or on storage device 306 to display graphical information for a graphical user interface (GUI) on an external input/output device, such as display 316 coupled to high speed interface 308. In another implementation, multiple processors and/or multiple buses may be used, as appropriate, along with multiple memories and types of memory. Also, multiple computing devices 300 may be connected, with each device providing portions of the necessary operations, e.g., as a server bank, a group of blade servers, or a multi-processor system, etc.

Memory 304 may store information within computing device 300. In one implementation, memory 304 may include a volatile memory unit or units. In another implementation, memory 304 may include a non-volatile memory unit or units. Memory 304 may also be another form of computer-readable medium, such as a magnetic or optical disk. A computer-readable medium may be defined as a non-transitory memory device. A memory device may include memory space within a single physical memory device or spread across multiple physical memory devices.

Storage device 306 may provide mass storage for computing device 300. In one implementation, storage device 306 may include a computer-readable medium, such as a floppy disk device, a hard disk device, an optical disk device, or a tape device, a flash memory or other similar solid state memory device, or an array of devices, including devices in a storage area network or other configurations. A computer program product may be tangibly embodied in an information carrier. The computer program product may also contain instructions that, when executed, perform one or more methods, such as those described below. The information carrier may include a computer or machine-readable medium, such as memory 304, storage device 306, or memory included within processor 302.

High speed controller 308 may manage bandwidth-intensive operations for computing device 300, while low speed controller 312 may manage lower bandwidth-intensive operations. Such allocation of functions is an example only. In one implementation, high-speed controller 308 may be coupled to memory 304, display 316, e.g., through a graphics processor or accelerator, and to high-speed expansion ports 310, which may accept various expansion cards (not shown). In the implementation, low-speed controller 312 may be coupled to storage device 306 and to low-speed expansion port 314. Low-speed expansion port 314, which may include various communication ports (e.g., USB, Bluetooth, Ethernet, wireless Ethernet) may be coupled to one or more input/output devices, such as a keyboard, a pointing device, a scanner, or a networking device, such as a switch or router, e.g., through a network adapter.

Computing device 300 may be implemented in a number of different forms, as shown in FIG. 3. For example, it may be implemented as a standard server 320, or multiple times in a group of such servers. It may also be implemented as part of a rack server system 324. Additionally or alternatively, computing device 300 may be implemented in a personal computer, such as a laptop computer 322. Additionally or alternatively, components from computing device 300 may be combined with other components in a mobile device (not shown), such as mobile computing device 350. Each of such devices may contain one or more of computing device 300, mobile computing device 350, and/or an entire system may be made up of multiple computing devices 300 and/or mobile computing devices 350 communicating with each other.

Mobile computing device 350 may include a processor 352, a memory 364, an input/output (I/O) device such as a display 354, a communication interface 366, and a transceiver 368, among other components. Mobile computing device 350 may also be provided with a storage device, such as a micro-drive or other device (not shown), to provide additional storage. Each of components 350, 352, 364, 354, 366, and 368, may be interconnected using various buses, and several of the components may be mounted on a common motherboard or in other manners as appropriate.

Processor 352 may execute instructions within mobile computing device 350, including instructions stored in memory 364. Processor 352 may be implemented as a set of chips that may include separate and multiple analog and/or digital processors. Processor 352 may provide, for example, for coordination of the other components of mobile computing device 350, such as, for example, control of user interfaces, applications run by mobile computing device 350, and/or wireless communication by mobile computing device 350.

Processor 352 may communicate with a user through control interface 358 and a display interface 356 coupled to a display 354. Display 354 may include, for example, a TFT LCD (Thin-Film-Transistor Liquid Crystal Display), an OLED (Organic Light Emitting Diode) display, and/or other appropriate display technology. Display interface 356 may comprise appropriate circuitry for driving display 354 to present graphical and other information to a user. Control interface 358 may receive commands from a user and convert them for submission to processor 352. In addition, an external interface 362 may be in communication with processor 352, so as to enable near area communication of mobile computing device 350 with other devices. External interface 362 may provide, for example, for wired communication in some implementations, or for wireless communication in other implementations, and multiple interfaces may also be used.

Memory 364 may store information within mobile computing device 350. Memory 364 can be implemented as one or more of a computer-readable medium or media, a volatile memory unit or units, or a non-volatile memory unit or units. Expansion memory 374 may also be provided and connected to mobile communication device 350 through expansion interface 372, which may include, for example, a SIMM (Single In Line Memory Module) card interface. Such expansion memory 374 may provide extra storage space for mobile computing device 350, or may also store applications or other information for mobile computing device 350. Specifically, expansion memory 374 may include instructions to carry out or supplement the processes described above, and may also include secure information. Thus, for example, expansion memory 374 may be provided as a security module for mobile computing device 350, and may be programmed with instructions that permit secure use of mobile computing device 350. In addition, secure applications may be provided via SIMM cards, along with additional information, such as placing identifying information on a SIMM card in a non-hackable manner.

Memory 364 and/or expansion memory 374 may include, for example, flash memory and/or NVRAM memory, as discussed below. In one implementation, a computer program product may be tangibly embodied in an information carrier. The computer program product may store instructions that, when executed, perform one or more methods, such as those described above. The information carrier may correspond to a computer- or machine-readable medium, such as the memory 364, expansion memory 374, or memory included within processor 352, that may be received, for example, over transceiver 368 or over external interface 362.

Mobile computing device 350 may communicate wirelessly through a communication interface 366, which may include digital signal processing circuitry where necessary. Communication interface 366 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 368. In addition, short-range communication may occur, such as using a Bluetooth, WiFi, or other such transceiver (not shown). In addition, a Global Positioning System (GPS) receiver module 370 may provide additional navigation- and location-related wireless data to mobile computing device 350, which may be used as appropriate by applications running on mobile computing device 350.

Mobile computing device 350 may also communicate audibly using an audio codec 360, which may receive spoken information from a user and convert it to usable digital information. Audio codec 360 may likewise generate audible sound for a user, such as through a speaker, e.g., in a handset of mobile computing device 350. Such sound may include sound from voice telephone calls, may include recorded sound (e.g., voice messages, music files, etc.) and may also include sound generated by applications operating on mobile computing device 350.

Mobile computing device 350 may be implemented in a number of different forms, as shown in FIG. 3. For example, it may be implemented as a cellular telephone 380. It may also be implemented as part of a smart phone 382, a personal digital assistant (not shown), and/or other similar mobile device.

Various implementations of the systems and techniques described herein may be realized in digital electronic circuitry, integrated circuitry, specially designed application specific integrated circuits (ASICs), computer hardware, firmware, software, and/or combinations thereof. These various implementations may include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) may include machine instructions for a programmable processor, and may be implemented in a high-level procedural and/or object-oriented programming language, and/or in assembly/machine language. As used herein, the terms “machine-readable medium” and “computer-readable medium” may refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” may refer to any signal used to provide machine instructions and/or data to a programmable processor.

To provide for interaction with a user, the systems and techniques described herein may be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices may be used to provide for interaction with a user as well; for example, feedback provided to the user may be any form of sensory feedback (e.g., visual feedback, auditory feedback, or tactile feedback); and input from the user may be received in any form, including acoustic, speech, or tactile input.

The systems and techniques described herein may be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the systems may be interconnected by any form or medium of digital data communication (e.g., a communication network). Examples of communication networks include a local area network (“LAN”), a wide area network (“WAN”), and the Internet.

Although FIG. 3 shows example components of computing device 300 and mobile computing device 350, computing device 300 or mobile computing device 350 may include fewer components, different components, additional components, or differently arranged components than depicted in FIG. 3. Additionally or alternatively, one or more components of computing device 300 or mobile computing device 350 may perform one or more tasks described as being performed by one or more other components of computing device 300 or mobile computing device 350.

### Supplementing Search Result in Response to User Triggers

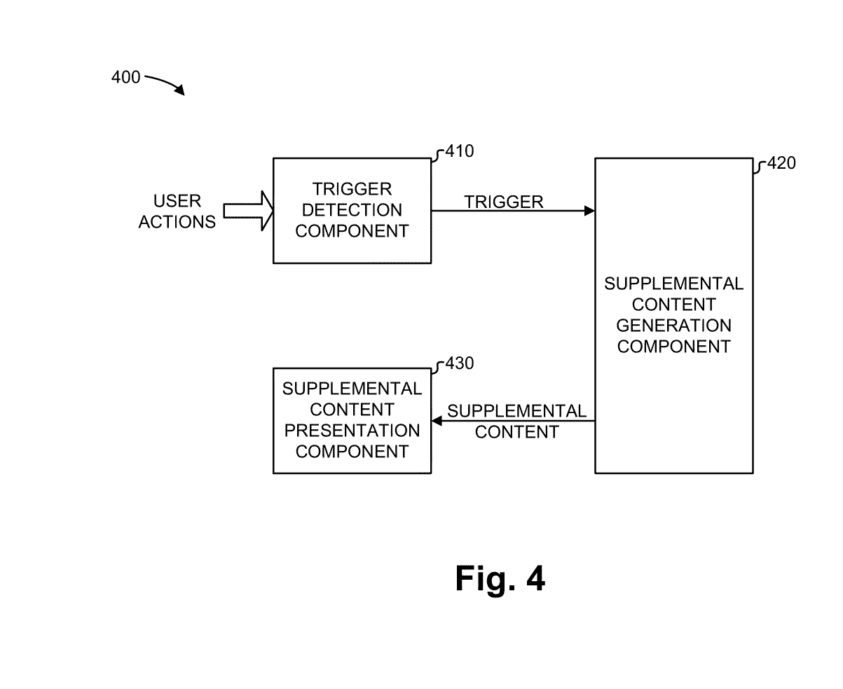

FIG. 4 is a diagram of example functional components 400 relating to the inclusion of supplemental content, in a search result document, in response to user actions. Functional components 400 may be implemented by client 205, server 210, or a combination of client 205 and server 210. Functional components 400 may include trigger detection component 410, supplemental content generation component 420, and supplemental content presentation component 430.

Trigger detection component 410 may detect one or more user actions that define a trigger condition, and output a trigger signal in response. The user actions may be user actions with respect to an interface presented by client 205, such as a user interface presented by a web browser executing at client 205. In one implementation, the interface may include a touch sensitive interface, and user touch actions may be detected by trigger detection component 410. Alternatively or additionally, other types of user actions, such as mouse movements, keyboard presses, etc., may be detected by trigger detection component 410.

The trigger conditions detected by trigger detection component 410 may include one or more trigger conditions that represent a user action or a sequence of user interactions. For example, a trigger condition may include a scroll down operation followed by a scroll up operation, where the scroll up and scroll down operations may be operations performed by the user on a touch sensitive display of client 205. For instance, the scroll down operation may include a finger touch gesture followed by a downward swipe and a scroll up operation may include a finger touch gesture followed by an upward swipe. In the context of browsing a web page, such as a search result document provided in response to a search query, a scroll down operation followed by a scroll up operation may indicate that the user browsed the search results, was not satisfied with the results, and is scrolling up to enter a new search in a search box at the top of the web page.

Other trigger conditions may alternatively or additionally be detected by trigger detection component 410. For example, trigger detection component 410 may output a trigger signal in response to two or more consecutive swipe left or swipe right operations, or in response to some other operation or sequence of operations. As previously mentioned, operations other than touch-based operations may potentially be detected and used by trigger detection component 410. In some implementations, a user may be allowed to specify a custom operation or sequence of operations that define a trigger condition.

In one implementation, trigger detection component 410 may be implemented as computer program instructions, such as a script, that is embedded within a web page, such as a hyper-text markup language (HTML) document. Alternatively or additionally, trigger detection component 410 may be implemented differently, such as part of a browser or as part of an add-on program for a browser, e.g., an addon toolbar.

Supplemental content generation component 420 may generate additional (supplemental) content that is to be provided to a user. The supplemental content may be content that is distinct from the initial search results. The supplemental content may modify the current content that is being presented to the user. The supplemental content may be provided to the user based on modification of a search results document that is being provided to the user. In one implementation, the supplemental content may include suggested search queries in which a user may be interested. The supplemental content may alternatively, or additionally, include different types of content, such as advertisements, search refinement suggestions, additional search results, or other types of content. Search refinement suggestions may include menus or other content that allows a user to quickly refine a query, such a tool to resubmit a version of the query that is additionally limited by date, location, or based on other refinement criteria.

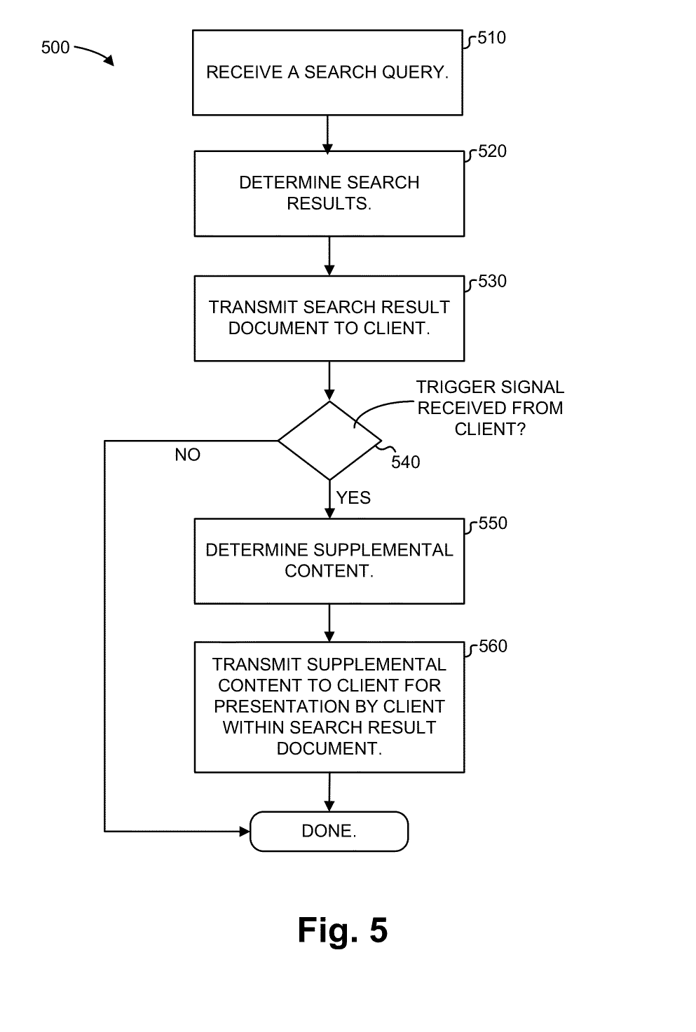

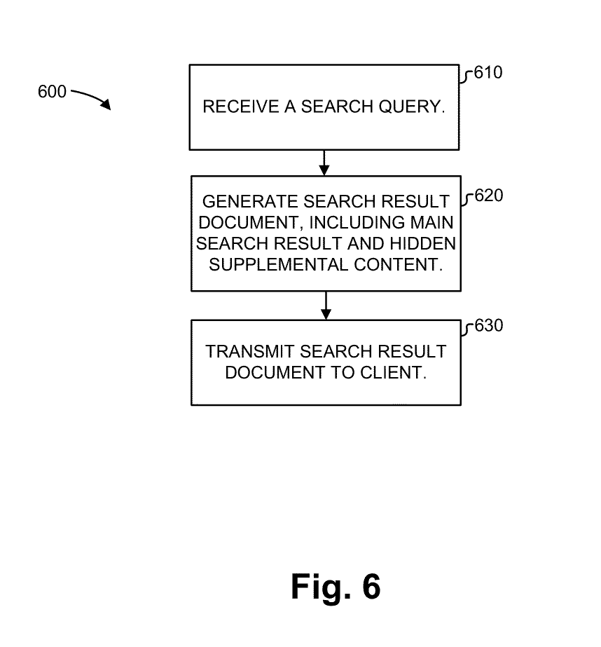

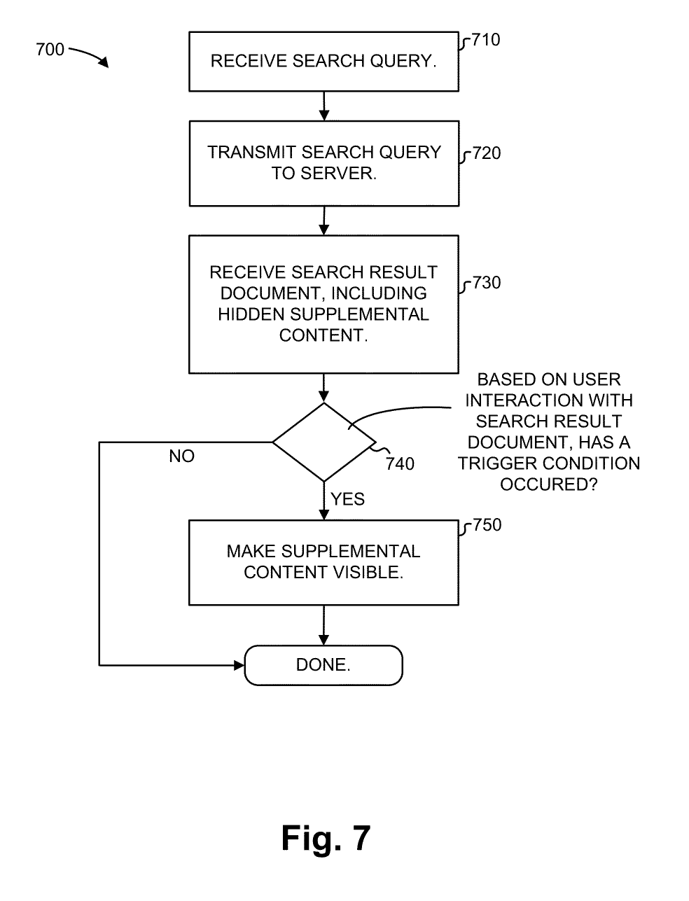

In one implementation, and as described in more detail below with reference to FIG. 5, supplemental content generation component 420 may operate to dynamically generate supplemental content in response to a trigger signal received from trigger detection component 410. In this case, the supplemental content may be transmitted, separately from an initial search result document, to a client 205. For instance, supplemental content may be fetched, by client 205 and from search server 210, in response to the trigger signal. In another implementation, and as described in more detail below with reference to FIGS. 6 and 7, supplemental content generation component 420 may generate content that is part of the initial search result document. The supplemental content may initially be hidden from the user, i.e., the supplemental content may not be initially presented to the user. In response to the trigger signal, the supplemental content may be made visible in the search result document.

Supplemental content presentation component 430 may provide the supplemental content to the user. Supplemental content presentation component 430 may include, for example, computer program instructions, such as a script, that is embedded within a search result document, to receive and or store the supplemental content. In some implementations, supplemental content presentation component 430 may immediately present received supplemental content. For example, supplemental content presentation component 430 may, when the supplemental content is received from search server 210, modify the search result document to present the supplemental content in a particular location, such as at the top of the search result document. In an alternative implementation, such as one in which the supplemental content is initially hidden within a search result document, supplemental content presentation component 430 may modify the search result document to present the supplemental content, when the trigger signal is generated by trigger detection component 410.

Although FIG. 4 illustrates an example of functional components 400 relating to the inclusion of supplemental content, functional components 400 may contain fewer components, different components, differently arranged components, and/or additional components than those depicted in FIG. 4. Alternatively, or additionally, one or more of functional components 400 may perform one or more other tasks described as being performed by one or more other of functional components 400.

FIG. 5 is a flow chart of an example process 500 for including supplemental content in a search result document. Process 500 may be performed by, for example, search server 210 in response to a search query from a client 205.

Process 500 may include receiving a search query (block 510). The search query may be received from a client 205, and may be, for example, a search query relating to a general web search, a news search, an image search, or another type of search.

In response to the received search query, search results may be determined (block 520). Search server 210 may, for instance, determine one or more documents that are relevant to the search query, such as documents that were previously indexed from web servers connected to network 230. Search server 210 may include links, to the relevant documents, in a search result document, which may be, for example, an HTML document. In addition to the links to the relevant documents, the search result document may include other information, such as snippet text that may be based on text that is obtained from the relevant documents.

The search result document may additionally include logic to implement trigger detection component 410 and/or supplemental content presentation component 430. For example, the search result document may include computer programming instructions, such as JavaScript, to monitor user interactions with the interface in which the search result document is provided, and to send a trigger signal to search server 210 when a trigger condition is detected. The search result document may also include programming instructions or other mechanisms, to provide the supplemental content, that is received from search server 210, to the user.

In some implementations, the search result document, transmitted by search server 210, may only include logic to implement trigger detection component 410 and/or supplemental content presentation component 430, for certain types of client devices 205. For instance, only client devices 205 that request a mobile search interface may include logic to implement trigger detection component 410. The mobile search interface may be an interface provided by search server 210, in which search server 210 optimizes the presentation of search results for relatively small graphical interfaces, such as those that are typically associated with smartphones or other highly portable devices.

Process 500 may further include transmitting the search result document to the client, such as a client 205 (block 530). Client 205, in response to receiving the search result document, may provide the search result document to the user. For example, a web browser executing at client 205 may render the search result document in a user interface at client 205.

At some point, a trigger signal, such as a trigger signal from client 205, may be received (block 540). The trigger signal may indicate that a trigger condition has been detected at client 205. As previously mentioned, an example of a trigger condition may be a scroll down operation followed by a scroll up operation. In some implementations, the trigger signal may include additional information, such as the current search query. In one implementation, the trigger signal may include a message that is transmitted, by client 205, in response to client 205 detecting a trigger condition.

Process 500 may further include, when a trigger signal is received from client 205 (block 540—YES), determining supplemental content (block 550). As previously mentioned, the supplemental content may include search query suggestions. In alternative implementations, the supplemental content may include other content, such as advertisements, search refinement suggestions, or other types of content. The supplemental content may be determined based on the search query but may be distinct from the search results. In some implementations, the supplemental content may be identified when the initial search result document is being generated. In this case, the supplemental content may be stored, by search server 210, until the trigger signal is received.

Process 500 may further include transmitting the supplemental content to client 205 for presentation by client 205 within the search result document (block 560). From the point of view of the user of client 205, the search result document that is currently being presented to the user, i.e., the web page showing the search result document, may change, to include the supplemental content. An example of supplemental content provided in a search result document is illustrated in FIG. 1B, in which the search result document shown in FIG. 1A is modified to include supplemental content, illustrated as search query suggestions 140. The supplemental content may be viewable when the user scrolls back to the top of the search result document.

FIG. 6 is a flow chart of an example process 600, according to another possible implementation, for including supplemental content in a search result document. Process 600 may be performed by, for example, search server 210. In contrast to process 500 (FIG. 5), process 600 may include supplemental content that is embedded, although not necessarily initially viewable, within the search result document that is initially transmitted to client 205.

Process 600 may include receiving a search query (block 610). The search query may be received from a client 205, and may be, for example, a search query relating to a general web search, a news search, an image search, or another type of search.

Process 600 may further include generating a search result document (block 620). The search result document may include the main search results and the supplemental content (block 620). The main search results may include links to one or more documents that are determined to be relevant to the search query. The search result document may include other information, such as snippets of text that summarize the relevant documents, and/or other information. The supplemental content may be initially hidden such that a user viewing the search result document in a browser will not see the supplemental content.

The search result document may additionally include logic to implement trigger detection component 410 and/or supplemental content presentation component 430. For example, the search result document may include computer programming instructions, such as JavaScript, to monitor user interactions with the interface in which the search result document is provided, and to issue a trigger signal when a trigger condition is detected. Content presentation component 430 may respond to the trigger signal to make the supplemental content visible to the user.

Process 600 may further include transmitting the search result document to client 205 (block 630). Client 205 may receive the search result document and provide via, for example, a web browser, the search result document to the user.

FIG. 7 is a flow chart of an example process 700 for presenting supplemental content to a user. Process 700 may be performed by, for example, client 205.

Process 700 may include receiving a search query (block 710). The search query may, for example, be a search query entered by a user in a web browser executing at client 205.

Process 700 may further include transmitting the search query to a server (block 720). The search query may be transmitted to a search engine, such as a search engine implemented by search server 210. The corresponding operation of search server 210 was described with respect to FIG. 6.

Process 700 may further include, in response to transmitting the search query, receiving a search result document, which may include hidden supplemental content (block 730). The search result document may additionally include the main search results. The main search results may be presented to the user, such as by rendering the search result document in a browser window.

Process 700 may further include determining, based on user interaction with the search result document, whether a trigger condition occurs (block 740). As previously mentioned, a trigger condition may be a user action or a sequence of user interactions. For example, a trigger condition may include a scroll down operation followed by a scroll up operation. Other trigger conditions may alternatively, or additionally, be used.

Process 700 may further include, when a trigger condition occurs, making the supplemental content visible (block 740—YES, and block 750). In one implementation, the supplemental content may be made visible near the top of the search result document, such as within an area below a search box. This positioning of the supplemental content may be particularly useful when the trigger condition indicates that the user may be scrolling towards the top of the document as the user may be scrolling back to the search box and is likely to notice the supplemental content. Alternatively, the supplemental content may be made visible in another part of the search result document, such as in a side margin.

In the situation in which the supplemental content is made visible near a top section of the search result document and when the user is viewing a lower section of the search result document, such as may tend to occur when the trigger condition is a scroll down operation followed by a scroll up operation, the supplemental content may be rendered in a portion of the search result document that is not immediately visible to the user and that does not modify the viewable area of the browser. This can be useful as it may not interrupt the browsing of the user.

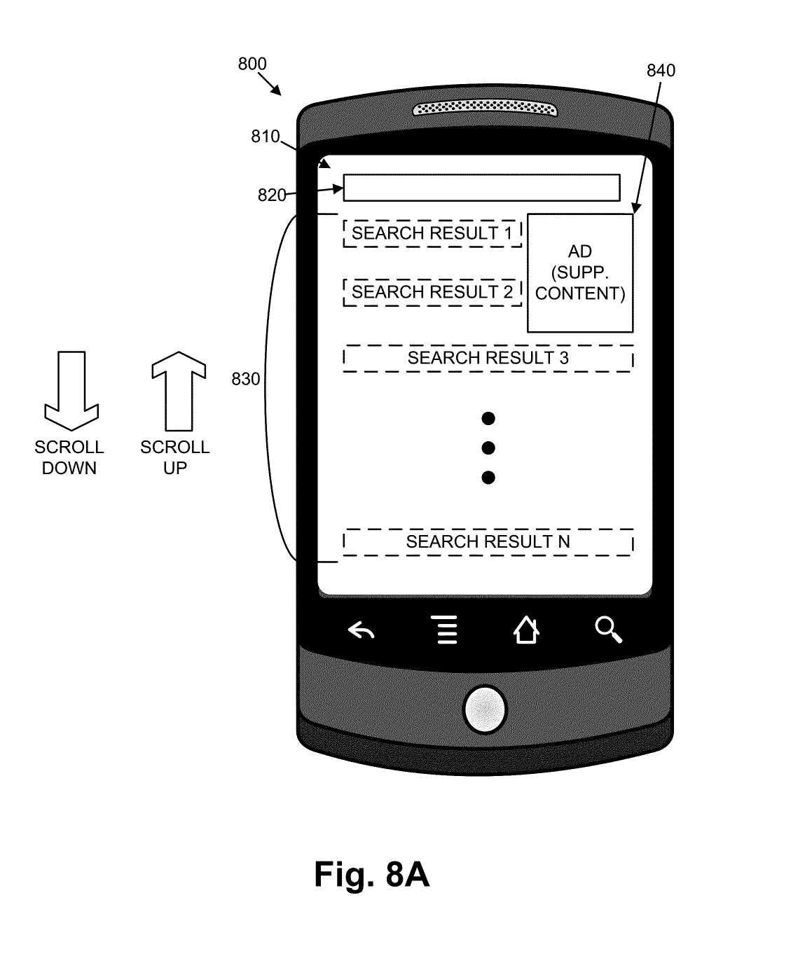

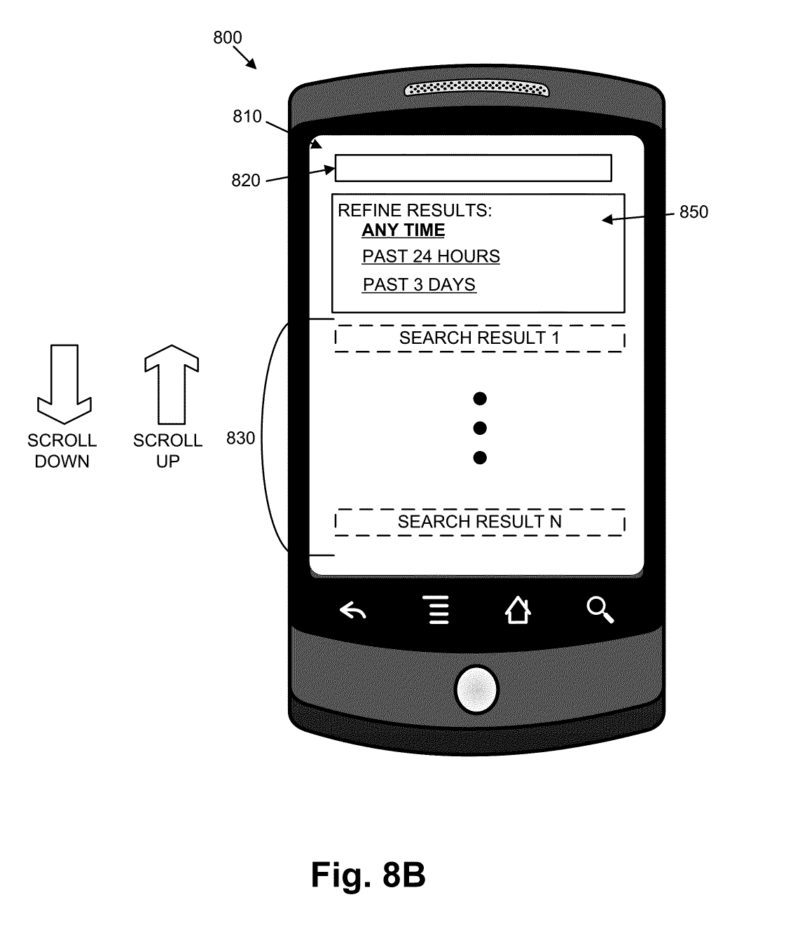

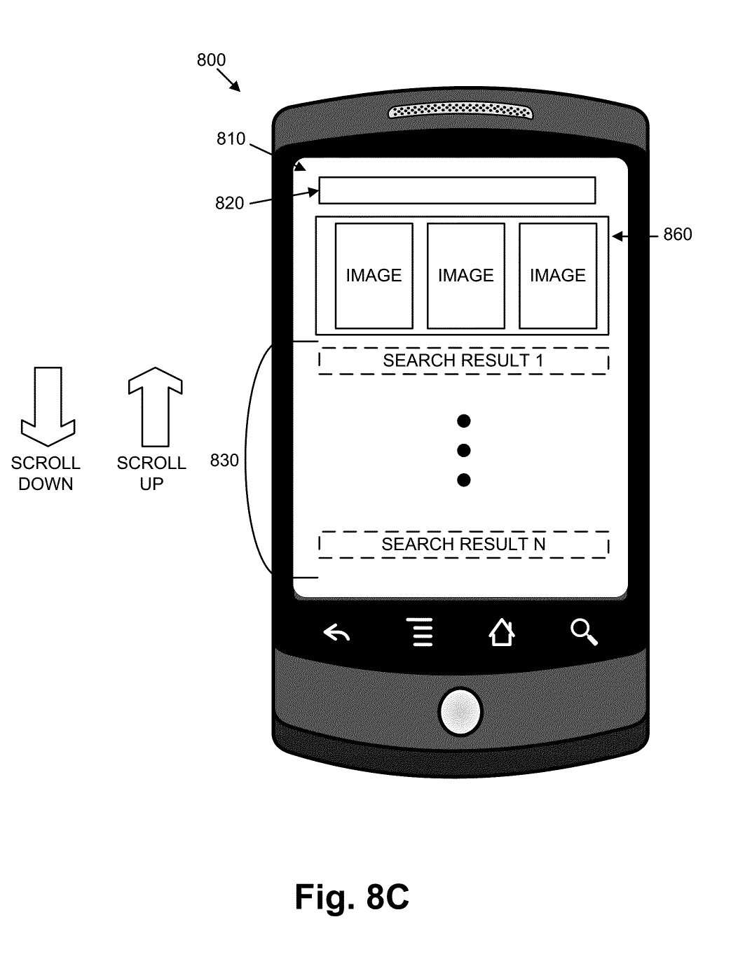

As described above, supplemental content may include a number of different types of supplemental content, such as search query suggestions, advertisements, query refinements, or other types of supplemental content. An example of providing search query suggestions as supplemental content, in response to a trigger condition, is shown in FIG. 1B. In FIG. 1B, search query suggestions are shown as textual links. In other possible implementations, search query suggestions may be shown in other ways, such as an image that generally represents a topic or query. Examples of supplemental content in the form of advertisements, query refinements, and images will next be given with reference to FIGS. 8A, 8B, and 8C.

FIG. 8A is a diagram illustrating an example user interface 810 that may be provided to the user. The user interface may be provided, by a browser program and on a mobile device 800, in response to submission of a search query to a search engine. This user interface 810 may include a search box 820, a quantity of search results 830 (search result 1 through search result N), and supplemental content 840, where supplemental content 840 is particularly illustrated as an advertisement (ad). Assume that the state of user interface 810, as shown in FIG. 8A, is a state that is provided after detection of a trigger condition. Prior to the trigger condition, supplemental comment 840 may not be visible in user interface 810. Thus, prior to the trigger condition, the first and second search results may extend horizontally across user interface 810. The trigger condition may be a user scroll down operation followed by a scroll up operation. Other trigger conditions may alternatively be used.

FIG. 8B is a diagram illustrating an example of another implementation of user interface 810. The user interface may be provided, by a browser program and on a mobile device 800, in response to submission of a search query to a search engine. User interface 810 may include search box 820, quantity of search results 830 (search result 1 through search result N), and supplemental content 850, where supplemental content 850 is particularly illustrated as an interface in which search query refinements are provided. In this example, the search query refinements include the ability to refine a user search query by date. For instance, by selecting a link, a user may refine the search results to only include search results that are published in the past 24 hours or past three days. Refining search results by date may be particularly useful for news searches. Assume that the version of user interface 810, as shown in FIG. 8B, is a version that is provided after detection of a trigger condition. Prior to the trigger condition, supplemental content 850 may not be visible in user interface 810. Thus, prior to the trigger condition, the search results 830 may be displayed directly below the search box 820. The trigger condition may be a user scroll down operation followed by a scroll up operation. Other trigger conditions may alternatively be used.

The search query refinements, corresponding to supplemental content 850, can include additional or alternative refinement conditions, other than date-based refinements. For example, refinement options relating to specific locations or content type, such as news documents, images, etc., may also be presented. Still further, supplemental content 850 may also include controls relating to the formatting of supplemental content 850. For example, supplemental content 850 may include a minimization control, expansion control, and/or a hide control, which may allow a user to selectively minimize, expand, and/or hide supplemental content 850.

In some implementations, the supplemental content may be displayed in a manner in which the overall layout or structure of a search result document is not changed. For example, in the example of FIG. 8B, the screen area taken by supplemental content 850 may, when the user initially views the search result document, be used to display other information, such as images or advertisements. In this situation, the images may be replaced by supplemental content 850. In another possible implementation, the supplemental content, in response to the trigger condition, may be moved within the structure of the search result document. For example, supplemental content 850 may be initially provided at the bottom of a search result document. In response to detection of the trigger condition, however, supplemental content 850 may be moved to a top of the search result document.

FIG. 8C is a diagram illustrating an example of another implementation of user interface 810. FIG. 8C may be similar to FIG. 8B, except that in FIG. 8C the supplemental content 860 may include images. The images may include thumbnail images of larger images and may represent, for example, content, search query suggestions, or query refinements.

Techniques were described herein to present supplemental content in a document, where the supplemental content is shown to the user in response to occurrence of a particular trigger condition. The trigger condition may include one or more user actions with respect to an user interface in which the document is provided. In one implementation, the trigger condition may be based on detection of a scroll down operation followed by a scroll up operation while browsing a webpage. Presenting supplemental content, in response to a trigger condition, may allow the supplemental content to be targeted to certain situations in which it is likely that the user is interested in the supplemental content. For example, a scroll down operation followed by a scroll up operation may mean that the user is likely to be interested in refining the previous search query, so providing supplemental content that assists the user in refining the search query may improve the browsing experience.

The foregoing description provides illustration and description, but is not intended to be exhaustive or to limit the embodiments to the precise form disclosed. Modifications and variations are possible in light of the above teachings or may be acquired from practice of these embodiments.

For example, while series of blocks have been described with regard to FIGS. 5-7, the order of the blocks may be modified in other implementations. Further, non-dependent blocks may be performed in parallel. In addition, other blocks may be provided, or blocks may be eliminated, from the described flowcharts, and other components may be added to, or removed from, the described systems.

It will be apparent that aspects described herein may be implemented in many different forms of software, firmware, and hardware in the implementations illustrated in the figures. The actual software code or specialized control hardware used to implement aspects does not limit the embodiments. Thus, the operation and behavior of the aspects were described without reference to the specific software code—it being understood that software and control hardware can be designed to implement the aspects based on the description herein.

It should be emphasized that the term “comprises/comprising,” when used in this specification, is taken to specify the presence of stated features, integers, steps, or components, but does not preclude the presence or addition of one or more other features, integers, steps, components, or groups thereof.

Even though particular combinations of features are recited in the claims and/or disclosed in the specification, these combinations are not intended to limit the disclosure of the implementations. In fact, many of these features may be combined in ways not specifically recited in the claims and/or disclosed in the specification. Although each dependent claim listed below may directly depend on only one other claim, the disclosure of the implementations includes each dependent claim in combination with every other claim in the claim set.

No element, act, or instruction used in the present application should be construed as critical or essential to the disclosed embodiments unless explicitly described as such. Also, as used herein, the article “a” is intended to include one or more items. Where only one item is intended, the term “one” or similar language is used. Further, the phrase “based on” is intended to mean “based, at least in part, on” unless explicitly stated otherwise.

1. A method performed by a device, the method comprising:
receiving, by the device, a search query;
obtaining, by the device, a search result document responsive to the search query, the search result document including one or more search results;
presenting, by the device, the search result document;
detecting, by the device and after presenting the search result document, performance of a sequence of actions,
the sequence of actions including a first action that causes the search result document to scroll down to a bottom portion of the search result document followed by a second action that causes the search result document to scroll up to a top portion of the search result document;
identifying, by the device and based on detecting the performance of the sequence of actions, one or more suggested search queries relating to the search query;
modifying, by the device and based on detecting the performance of the sequence of actions, the search result document to include:
the one or more suggested search queries, and
one or more search query refinements to refine the search query,
the search result document being modified only after the performance of the sequence of actions is detected; and
presenting, by the device, the modified search result document.

2. The method of claim 1, where presenting the modified search result document includes:
presenting the one or more suggested search queries in a top portion of the modified search result document after detecting the performance of the sequence of actions.

3. The method of claim 1, where the search result document further includes instructions to detect the sequence of actions.

4. The method of claim 1, where obtaining the search result document includes:
identifying the one or more search results,
where the one or more suggested search queries are identified as supplemental content for the search result document.

5. The method of claim 1, where modifying the search result document includes modifying the search result document to further include one or more images that represent at least one of a suggested search query, of the one or more suggested search queries, or the one or more search query refinements, after detecting the performance of the sequence of actions.

6. The method of claim 1, where detecting the performance of the sequence of actions includes detecting the first action and the second action as being performed on a touch screen display.

7. The method of claim 1, where modifying the search result document includes:
modifying a visual presentation of the search result document to further include at least one of:
an advertisement, or
an additional search result.

8. A non-transitory computer-readable medium storing instructions, the instructions comprising:
one or more instructions which, when executed by one or more processors, cause the one or more processors to receive a search query;
one or more instructions which, when executed by the one or more processors, cause the one or more processors to obtain a search result document responsive to the search query,
the search result document including one or more search results;
one or more instructions which, when executed by the one or more processors, cause the one or more processors to present the search result document;
one or more instructions which, when executed by the one or more processors, cause the one or more processors to detect performance of a sequence of actions,
the sequence of actions including a first action that causes the search result document to scroll down toward a bottom portion of the search result document followed by a second action that causes the search result document to scroll up toward a top portion of the search result document;
one or more instructions which, when executed by the one or more processors, cause the one or more processors to identify, based on detecting the performance of the sequence of actions, supplemental content that includes:
one or more suggested search queries relating to the search query, and
one or more search query refinements to refine the search query;
one or more instructions which, when executed by the one or more processors, cause the one or more processors to modify the search result document to include the supplemental content that includes the one or more suggested search queries and the one or more search query refinements,
the search result document being modified only after detecting the first action followed by the second action; and
one or more instructions which, when executed by the one or more processors, cause the one or more processors to present the modified search result document.

9. The non-transitory computer-readable medium of claim 8, the instructions further comprising:
one or more instructions which, when executed by the one or more processors, cause the one or more processors to present the one or more suggested search queries in a top portion of the modified search result document after detecting the performance of the sequence of actions.

10. The non-transitory computer-readable medium of claim 8, where the search result document further includes code to detect the sequence of actions.

11. The non-transitory computer-readable medium of claim 8, where the one or more instructions to obtain the search result document include:
one or more instructions which, when executed by the one or more processors, cause the one or more processors to identify the one or more search results.

12. The non-transitory computer-readable medium of claim 8, where the one or more search query refinements refine the search query based on at least one of a particular location or a particular content type, and
where the supplemental content further includes an advertisement or an additional search result.

13. The non-transitory computer-readable medium of claim 8, where the one or more instructions to detect performance of the sequence of actions include one or more instructions to detect the first action and the second action as being performed on a touch screen display.

14. The non-transitory computer-readable medium of claim 8, where the one or more instructions to modify the search result document include:
one or more instructions which, when executed by the one or more processors, cause the one or more processors to modify a visual presentation of the search result document to include the supplemental content and at least one of:
an advertisement, or
one or more images that represent at least one of a suggested search query, of the one or more suggested search queries, or a search query refinement of the one or more search query refinements.

15. A computing device comprising:
a memory to store instructions; and
one or more processors, to execute the instructions, to:
receive a search query,
obtain a search result document responsive to the search query,
the search result document including one or more search results,
present the search result document,
detect performance of a sequence of actions,
the sequence of actions including a first action that causes the search result document to scroll down to a first section of the search result document followed by a second action that causes the search result document to scroll up to a second section of the search result document,
identify, based on detecting the performance of the sequence of actions, supplemental content that includes a plurality of:
one or more suggested search queries relating to the search query,
one or more search query refinements to refine the search query, or
one or more images that represent at least one of a suggested search query relating to the search query or a search query refinement to refine the search query;
modify the search result document to include the supplemental content based on detecting the performance of the sequence of actions,
the search result document being modified only after the performance of the sequence of actions is detected; and
present the modified search result document.

16. The computing device of claim 15, where the one or more processors further execute the instructions to present the one or more suggested search queries in a top portion of the modified search result document after detecting the performance of the sequence of actions,
where the first section corresponds to a bottom portion of the search result document, and
where the second section corresponds to a top portion of the search result document.

17. The computing device of claim 15, where the search result document further includes instructions to detect the sequence of actions.

18. The computing device of claim 15, where, when obtaining the search result document, the one or more processors further execute the instructions to:
identify the one or more search results.

19. The computing device of claim 15, where the one or more search query refinements refine the search query based on a period of time, a particular location, or a particular content type, and
where the supplemental content further includes an advertisement.

20. The computing device of claim 15, where, when detecting the performance of the sequence of actions, the one or more processors are to detect the first action and the second action as being performed on a touch screen display.

21. The computing device of claim 15, where, when modifying the search result document, the one or more processors are to:
modify a visual presentation of the search result document to include:
the supplemental content, and
a plurality at least one of:
an advertisement, or
an additional search result.
